(19) United States
(12) Patent Application Publication
(10) Pub. No.: US 2017/0053247 A1
(43) Pub. Date: Feb. 23, 2017

(54) COSMETIC SERVICES ACCESS SYSTEM

(71) Applicants: Daniel Carnot, Hampton, GA (US); Felix Meshman, Woodmere, NY (US)

(72) Inventors: Daniel Carnot, Hampton, GA (US); Felix Meshman, Woodmere, NY (US)

(21) Appl. No.: 14/830,996

(22) Filed: Aug. 20, 2015

(51) Int. Cl. G06Q 10/10

(52) U.S. Cl. CPC G06Q 10/1095

(57) ABSTRACT

A system for scheduling cosmetic treatments comprising: a database of cosmetic salons; a central processing unit, where the central processing unit maintains the database of cosmetic salons and permits end user access to the database; a network, where the central processing unit connects to the network and provides a means for end user access to the database; end user software, where the end user software provides interactive functions with the central processing unit and the database of cosmetic salons; and a portable electronic device associated with each end user, where the portable electronic device receives and stores the end user software. Preferably, the cosmetic salons offer a plurality of services, where the plurality of services includes at least one of manicure, pedicure or waxing services. The interactive functions may include scheduling, pricing, location, directions and payment for the plurality of services.

### BACKGROUND OF THE INVENTION

Field of Invention

The present invention relates to a system and application to locate and schedule cosmetic services such as manicures or pedicures.

Description of Related Art

Mobile software applications are commonly implemented in portable electronic devices such as smartphones and tablets. These mobile applications allow additional functionality and interactivity with the smartphone or tablet. Mobile applications were distributed through various software platforms associated with the portable electronic device. These applications provide various types of interaction for the user such as gaming opportunities, information portals, mapping solutions, Internet assets and numerous other applications associated with the various daily functions.

Many individuals enjoy and incorporate manicures, pedicures and other treatments and services for aesthetic purposes. Manicures and pedicures are essentially cosmetic beauty treatments for fingernails, hands, toenails and feet. Typically these treatments are done at beauty salons specifically designed for providing such services. As a result, individuals usually schedule service at a salon or in certain instances simply arrive at the salon for a treatment. One drawback to receiving the services is the waiting time that is frequently associated with receiving the service. Many times the salons can be crowded at certain times and inconvenient for certain users. Because there are many options available for consumers it would be advantageous to have a mobile application that will provide a user with opportunity to schedule and to also arrange for manicure or pedicure services at various locations.

### SUMMARY OF THE INVENTION

The present invention relates to a system for scheduling cosmetic treatments comprising: a database of cosmetic salons; a central processing unit, where the central processing unit maintains the database of cosmetic salons and permits end user access to the database; a network, where the central processing unit connects to the network and provides a means for end user access to the database; end user software, where the end user software provides interactive functions with the central processing unit and the database of cosmetic salons; and a portable electronic device associated with each end user, where the portable electronic device receives and stores the end user software. Preferably, the cosmetic salons offer a plurality of services, where the plurality of services includes at least one of manicure, pedicure or waxing services. The interactive functions may include scheduling, pricing, location, directions and payment for the plurality of services. The end user software provides an access icon on the portable electronic device, where the portable electronic device includes a smartphone or a tablet.

### BRIEF DESCRIPTION OF DRAWINGS

FIG. 1 depicts a smartphone with a mobile application icon associated with the manicure salon access system according to the present invention.

### DETAILED DESCRIPTION

The present invention relates to a mobile application that is used for salon scheduling and access by end users. This system is developed through the use of a mobile software application that is available through common distribution systems on an individual's smartphone or tablet. The system includes a database, which stores a plurality of salon locations. Further end users can access through the database of locations via a mobile application software provided on their portable electronic device. A central computing system stores the database and updates locations and scheduling associated with each salon location. The end users who access this database through the mobile application select an appropriate or convenient salon location and then schedule services desired. In addition to scheduling services the system also may provide an opportunity for prepayment of such services through the mobile application, may further encourage discounts and other transactions through the mobile applications associated with salon services.

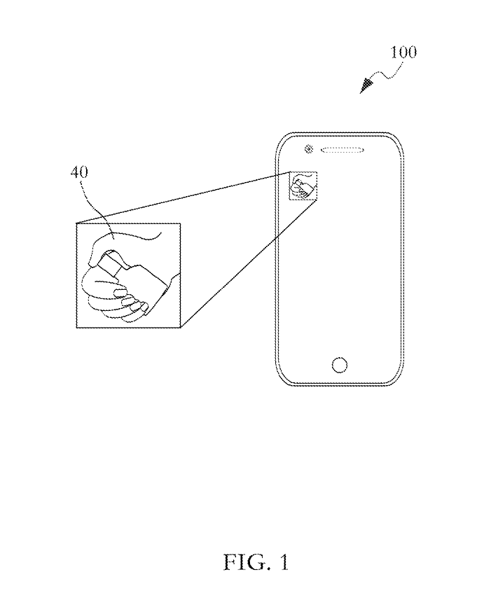

In reference to FIG. 1, a smartphone 100 is depicted with an icon 40 shown. The icon 40 represents an exemplary icon to be associated with the mobile application in accordance with the present invention. FIG. 1 depicts the end user hardware that's associated with the salon access system according to the present invention. Although depicted as a smartphone the portable electronic device may also include a tablet that's commonly used by consumers.

The present invention includes a central processing system that includes software to manage a database of salon locations. The salon locations allow access to their business information through the mobile application. End users connect to the central processing system through their portable electronic device via a network such as the Internet. This interconnection between the end users and the central processing system allows the end users to access a plurality of salon locations. These salon locations provide location information, pricing, hours and scheduling opportunities for end users. Further features of the mobile application may include opportunities to not only schedule the salon appointments but also to purchase and pay for salon services prior to arrival. The system as a result provides a transfer of information and business transactions related and associated with salon treatments. Various salon treatments as a result may be available through the mobile application such as manicures, pedicures, waxing and other cosmetic beauty treatments. The mobile application of the present invention is accessible through the various distribution systems available to the end user. The instant invention has been shown and described in what it considers to be the most practical and preferred embodiments. It is recognized, however, that departures may be made there from within the scope of the invention and that obvious modifications will occur to a person skilled in the art.

What is claimed is:

1. A system for scheduling cosmetic treatments comprising:
a. a database of cosmetic salons;
b. a central processing unit, where the central processing unit maintains the database of cosmetic salons and permits end user access to the database;
c. a network, where the central processing unit connects to the network and provides a means for end user access to the database;
d. end user software, where the end user software provides interactive functions with the central processing unit and the database of cosmetic salons; and
e. a portable electronic device associated with each end user, where the portable electronic device receives and stores the end user software.

2. The system according to claim 1, where the cosmetic salons offer a plurality of services.

3. The system according to claim 1, where the plurality of services includes at least one of manicure, pedicure or waxing services.

4. The system according to claim 2, where the interactive functions include scheduling, pricing, location, directions and payment for the plurality of services.

5. The system according to claim 1, where the end user software provides an access icon on the portable electronic device.

6. The system according to claim 1, where the portable electronic device includes a smartphone or a tablet.
